(19) United States
(12) Patent Application Publication
(10) Pub. No.: US 2006/0165092 A1
(43) Pub. Date: Jul. 27, 2006

(54) Out-of-band signaling system, method and computer program product

(75) Inventors: Tim Wilson, Bedford (CA); Peter Macaulay, Reston, VA (US); Brad Dixon, London (CA)

Correspondence Address: VENABLE LLP, P.O. BOX 34385, WASHINGTON, DC, 20045-9998, US

(73) Assignee: Agovo Communications, Inc.

(21) Appl. No.: 11/316,344

(22) Filed: Dec. 23, 2005

Related U.S. Application Data
(60) Provisional application No. 60/638,356, filed on Dec. 23, 2004.

(51) Int. Cl. H04L 12/56

(52) U.S. Cl. 370/395.21; 370/235

(57) ABSTRACT

A system, method and computer program product for providing a user a way to change communications presence information is disclosed. A point of presence (PPD) device may produce presentity (a source of presence information about a user) which may be transmitted out-of-band to a watcher or watchers of an intelligent call handling presence server.

### CROSS-REFERENCE TO RELATED PATENT APPLICATIONS

This application is a non-provisional application and claims priority to U.S. Provisional Patent Application No. 60/638,356, filed Dec. 23, 2004, of common assignee to the present invention, the contents of which are incorporated herein by reference in their entirety.

### BACKGROUND OF THE INVENTION

1. Field of the Invention

The present invention is related to communications, and more particularly to signaling for telephony communications.

2. Related Art

A conventional user of telephony services may have a plurality of telephony devices. For example, a real estate sales person may have two phone lines in her home, a mobile phone, a phone at her brokerage's office, as well as a conference room phone on a third party's (such as, e.g., but not limited to, her lawyer's) location. It is conventionally difficult for the sales person to have her calls routed to her, instead, she usually may maintain multiple voicemail mailboxes at the various locations in order to ensure she receives telephone calls. Also, when she does not want to be disturbed, it is very difficult for her to screen calls, other than to either accept all or no calls by, e.g., turning off here mobile phone, or reviewing caller ID data and ignoring incoming calls. What is needed is an improved technique of controlling telephony and other communications and computing devices that overcomes shortcomings of conventional solutions.

### SUMMARY OF THE INVENTION

Various exemplary features and advantages of the invention, as well as the structure and operation of various exemplary embodiments of the invention, are described in detail below with reference to the accompanying drawings.

A system, method and computer program product for providing a user a way to change communications presence information is disclosed. A point of presence (PPD) device may produce presentity (a source of presence information about a user) which may be transmitted out-of-band to a watcher and/or watchers of an intelligent call handling presence server.

In an exemplary embodiment, the PPD device, according to an exemplary embodiment of the present invention, may be used to set presentity information which may include, e.g., but not limited to, availability (avail), modality of communication (mode), and/or location].

An exemplary embodiment of the present invention may include a method, which may include, receiving a registration from a user for an out-of-band signaling service provider, including (in an exemplary embodiment): associating at least one communications device with the out-of-band signaling service provider; setting a plurality of possible locations of the user; setting a plurality of possible levels of availability; setting a plurality of possible modalities of communications; and receiving a selection of an initial presence for the user, wherein the presence may include a location selected from the plurality of possible locations, a level of availability selected from the plurality of possible levels of availability, and a modality of communication selected from the plurality of possible modalities of communications; provisioning at a communication system a communications channel to route calls to the user according to the presence; receiving a new selection of a new presence from the user over an out-of-band signaling system; reprovisioning at the communications system to route calls to the user according to the new presence; and sending an acknowledgement of receipt of the new selection of the new presence.

Another exemplary embodiment of the present invention may include the method where the receiving the selections of the presence over the out-of-band signaling system may include receiving the selections over a signaling system may include at least one of: a general packet radio service (GPRS) signaling system of global system for mobile communications (GSM) signaling technology, a short messaging system (SMS), a packet channel upon any mobile bearer channel, a packet radio signaling system, a two way packet pager signaling system, a code division multiple access (CDMA) signaling system, a WI-FI signaling system, a WI-MAX signaling system, a IP telephony signaling system, a IP packet system to transmit packets, a PSTN signaling systems employing voice recognition signaling, an Interactive Voice Response (IVR) signaling, a DTMF signaling, and/or a Bluetooth signaling system that can communicate with any other Bluetooth compatible device that has wireless signaling capabilities outlined. Any other modality may similarly be used.

Another exemplary embodiment of the present invention may include the method where the packet channel upon any mobile bearer channel includes at least one of, but not limited to, GSM, GPRS, CDMA, TDMA, iBurst, WiMax, WiFi, and/or iDEN. Any other modality, including, e.g., but not limited to, any of a number of radio frequency (RF) modalities, presently available, or available in the future, and the examples provided are exemplary, but non-limiting. Other exemplary embodiments may include, e.g., but not limited to, UMTS, 1×EVDO, CDMA2000, W-CDMA, EDGE, and other 3^{rd} generation wireless, including spread spectrum technologies, 4^{th} generation wireless technologies, including, but not limited to, HSDPA and HSUPA, and all future generation wireless technologies (e.g., but not limited to, 5^{th}, 6^{th}, 7^{th}, . . . n^{th} , etc.).

Another exemplary embodiment of the present invention may include the method where the IP telephony signaling system uses at least one of an MGCP, SIP, and/or RTP protocols.

Another exemplary embodiment of the present invention may include the method where wireless signaling capabilities are adapted to communicate with a GSM cell phone and/or a Bluetooth Laptop on an IP network.

Another exemplary embodiment of the present invention may include the method where the IP packet system includes TCP/IP and/or UDP transport protocols to transmit packets.

Another exemplary embodiment of the present invention may include the method where the packet radio signaling system uses iText.

Yet another exemplary embodiment of the present invention may include the method where the receiving the selections, which may include receiving the selections from a point of presence device.

Another exemplary embodiment of the present invention may include the method where the point of presence device may include a signaling fob apparatus. In an exemplary embodiment, the fob may be a handheld, keychain, and/ or keyfob device. In another exemplary embodiment, the fob may be an application and/or applet on a computing or communications device such as, e.g., but not limited to, a personal computer (PC), personal digital assistant (PDA), etc. In an exemplary embodiment, the Vob may be about 2 inches long may include a menu key, a blacklight display, soft keys, programmable keys, and may include a displayable menu. In another exemplary embodiment, the Vob may be incorporated into an intelligent handheld device, a smart phone, a PDA, a RIM BLACKBERRY® type device.

Yet another exemplary embodiment of the present invention may include the method where the receiving the selections, may include receiving an encrypted selection.

An exemplary embodiment of the present invention may include the method where the receiving the selections, may include receiving the selections over a secure communications link.

Another exemplary embodiment of the present invention may include a system, which may include: means for receiving a registration from a user for an out-of-band signaling service provider, which may include: means for associating at least one communications device with the out-of-band signaling service provider; means for setting a plurality of possible locations of the user; means for setting a plurality of possible levels of availability; means for setting a plurality of possible modalities of communications; and means for receiving a selection of an initial presence for the user, wherein the presence may include a location selected from the plurality of possible locations, a level of availability selected from the plurality of possible levels of availability, and a modality of communication selected from the plurality of possible modalities of communications; means for provisioning at a communication system a communications channel to route calls to the user according to the presence; means for receiving a new selection of a new presence from the user over an out-of-band signaling system; means for reprovisioning at the communications system to route calls to the user according to the new presence; and means for sending an acknowledgement of receipt of the new selection of the new presence.

Another exemplary embodiment of the present invention may include a computer program product embodied on a computer readable media, the computer program product adapted to enable a processor to execute a method, wherein the method may include: receiving a registration from a user for an out-of-band signaling service provider, including: associating at least one communications device with the out-of-band signaling service provider; setting a plurality of possible locations of the user; setting a plurality of possible levels of availability; setting a plurality of possible modalities of communications; and receiving a selection of an initial presence for the user, wherein the presence may include a location selected from the plurality of possible locations, a level of availability selected from the plurality of possible levels of availability, and a modality of communication selected from the plurality of possible modalities of communications; provisioning at a communication system a communications channel to route calls to the user according to the presence; receiving a new selection of a new presence from the user over an out-of-band signaling system; reprovisioning at the communications system to route calls to the user according to the new presence; and sending an acknowledgement of receipt of the new selection of the new presence.

Out-of-band (OOB) signaling can be done by a variety of means according to an exemplary embodiment. According to an exemplary embodiment, way OOB may be used to specify. According to an exemplary embodiment, server may handle SS7 calls and VoIP seamlessly. According to an exemplary embodiment, the server may route all other types of communications as per users' directions (e.g., but not limited to, Presence, Availability and Modality). Including Email, IM, Fax, Pager, etc. According to an exemplary embodiment, an exemplary server may store user contact information (from Outlook) and may use this information to route calls. According to an exemplary embodiment, the server may learn (usin a knowledge base, expert system, machine learning, and/or artificial intelligence(AI)) from how a user may handle a call (accept or park or modality) and may generate rules that the user can implement (Acts as a personal assistant).

Using the Vob according to an exemplary embodiment, the user may decide with whom the user may wish to speak (presence), when the user wishes to speak (selective availability), on the device of their choice (modality) in seconds (ease of seconds), at the user's discretion (user-centric).

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. A preferred exemplary embodiment is discussed below in the detailed description of the following drawings:

FIG. 1 depicts an exemplary embodiment of point of presence device according to the present invention;

FIG. 2 depicts an exemplary embodiment of a signaling system according to the present invention;

FIG. 3 depicts an exemplary embodiment of an intelligent call handling server signaling system according to the present invention;

FIG. 4 depicts an exemplary embodiment of a telephony management call forwarding override according to the present invention;

FIG. 5 depicts an exemplary embodiment of a system overview of the present invention;

FIG. 6 depicts an exemplary computer system that may be used in implementing an exemplary embodiment of the present invention;

FIG. 7 depicts an exemplary user registration according to the present invention;

FIG. 8 depicts an exemplary embodiment of an exemplary user interaction with the present invention;

FIG. 9 depicts an exemplary embodiment of another exemplary user interaction with the present invention;

FIG. 10 depicts an exemplary embodiment of yet another exemplary user interaction with the present invention;

FIG. 11 depicts an exemplary embodiment of an exemplary user interaction with the present invention;

FIG. 12 depicts an exemplary embodiment of an exemplary interactive television environment according to an exemplary embodiment of the present invention;

FIG. 13A depicts an exemplary embodiment of one exemplary embodiment of an ITV device according to the present invention; and

FIG. 13B depicts another exemplary embodiment of one exemplary embodiment of an ITV device according to the present invention.

### DETAILED DESCRIPTION OF EXEMPLARY EMBODIMENTS OF THE PRESENT INVENTION

A preferred embodiment of the invention is discussed below as well as various other exemplary, but non-limiting embodiments. While specific implementations are discussed, it should be understood that this is done for illustration purposes only. A person skilled in the relevant art can recognize that other components and configurations may be used without parting from the spirit and scope of the invention.

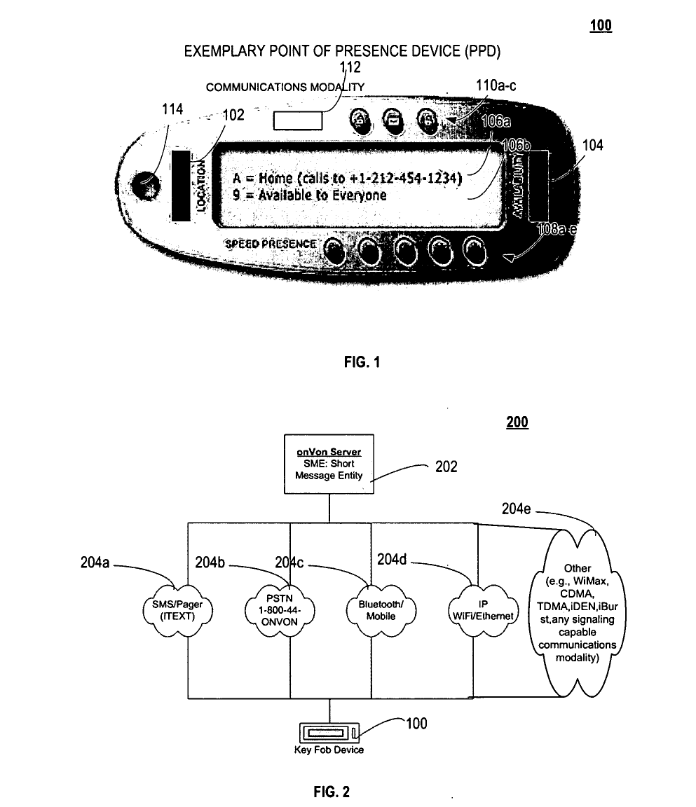

FIG. 1 depicts an exemplary embodiment of the present invention including a point-of-presence device (PPD) 100. In an exemplary embodiment, the PPD 100 may include one or more input and output devices as well as signal communication capabilities. In an exemplary embodiment, PPD 100 may include, for example, but not limited to, and not required, a location selector 102, an availability selector 104, a communications modality selector 112, and a display 106. In an exemplary embodiment, the PPD 100 may further include one or more buttons 110 which may be used, e.g., but not limited to, and not required, to lock 110a the PPD 100, to access email 110b, to set encryption level 110c, etc. PPD 100, in an exemplary embodiment may be used to select a presence for a user of PPD 100. The presence, in an exemplary embodiment may include a location, and availability, which may include a selected communications modality as well. In one exemplary embodiment, a PPD 100 may have initialize with a default presence. IN another exemplary embodiment, the PPD 100 may be initialized by a user selection of a selected presence. In an exemplary embodiment, a number of preset speed presences may be set on PPD 100, as shown and referenced as speed preference buttons 108a-e. The PPD 100 device, in an exemplary embodiment may be of a miniature form factor, e.g., the size of a key, or watch fob. In one exemplary embodiment, the PPD 100 may be adapted to be coupled to other things via coupling hole 114, or other couplers as will be apparent to those skilled in the relevant art. In an exemplary embodiment, a current presence, initialized presence, or selected presence may be displayed on display 106. In an exemplary embodiment, selections of, e.g., but not limited to, and not required, a location designation 106a, in this case a letter designating home, and an availability designation 106b, in this case a number designating availability to be reached by anyone. In another exemplary embodiment, other information may be displayed, such as, e.g., but not limited to, any of various communications modality, including, e.g., but not limited to, a plain old telephone system (PSTN) phone, a voice over Internet Protocol (VOIP) phone or device, an communications device or computing device (such as, e.g., but not limited to, a processor, a computer, a personal computing device, a mobile device, a mobile phone, a personal digital assistant (PDA), a handheld, desktop, server, laptop, mobile, an interactive television (ITV) device, an Internet telephony device, a wired device, a wireless device, a CATV device, a blue tooth, WiFi, WiMax, PSTN, CDMA, TDMA, iDEN, iBurst, a signaling device, etc.)

FIG. 2 depicts an exemplary embodiment of a communications architecture 200, including, in an exemplary embodiment, various exemplary out-of-band (OOB) messaging modalities 204a-204e over which PPD 100 may communicate out-of-band from an exemplary intelligent call handling server 202. In an exemplary embodiment, PPD 100 may communicate over a single communications modality 204a-e. In another exemplary embodiment, the PPD 100 may be adapted to communicate over more than one of the exemplary communications modalities 204a-e.

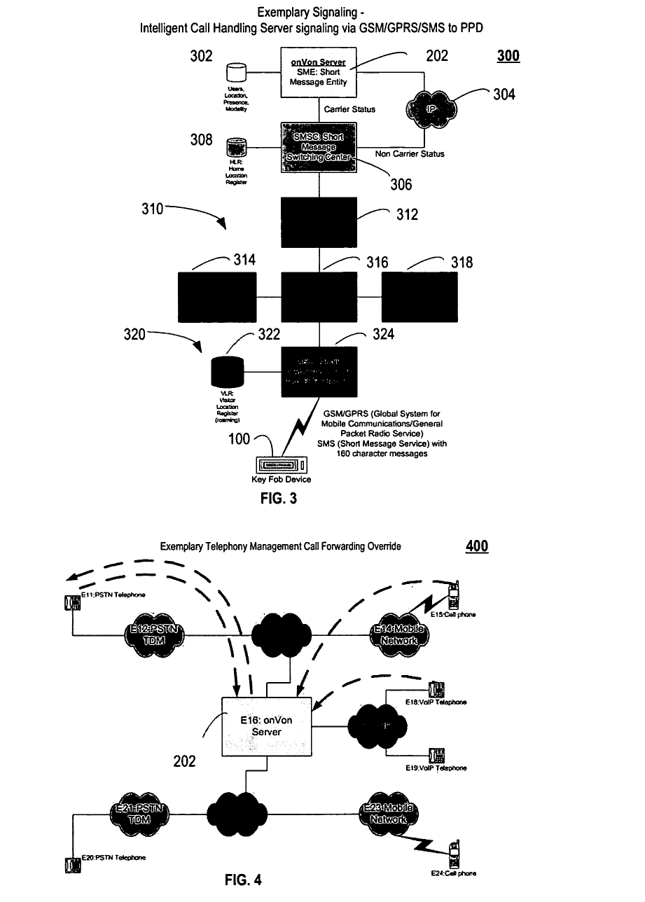

FIG. 3 depicts an exemplary embodiment of a diagram 300 illustrating an exemplary signaling system. In an exemplary embodiment of diagram 300, PPD 100 may communicate via, e.g., but not limited to, a global system for mobile communications (GSM)/global packet radio service (GPRS)/short message service (SMS), to a mobile switching center (MSC) system 320 including MSC 324. In an exemplary embodiment, MSC 324 may include an STP interface and may be used to communicate with a signaling system 310. The signaling system 310 may be the signaling system seven (SS7) signaling system commonly used for call signaling in the PSTN. From the signaling system 310, signaling may be communicated via a short message switching center 306 to the intelligent call handling server 202. Communication may occur over an IP network 304.

FIG. 3 includes a Signaling System 7 (SS7) signaling network 310. Signaling network 310 illustrates an exemplary signaling network. The SS7 network is a separate network conventionally used to handle the set up, tear down, and supervision of calls between calling party and called party. Signaling network 310 in the given example is the Signaling System 7 (SS7) network. Signaling network 310 may include service switching points (SSPs) 318, signal transfer points (STPs) 312, 316, and service control point (SCP) 314.

In the SS7 network, the SSPs are the portions of the backbone switches providing SS7 functions. The SSPs can be, for example, a combination of a voice switch and an SS7 switch, or a computer connected to a voice switch. The SSPs may communicate with the switches using primitives, and may create packets for transmission over the SS7 network.

The STPs may act as routers in the SS7 network, typically being provided as adjuncts to in-place switches. The STPs route messages from originating SSPs to destination SSPs. Architecturally, STPs can and are typically provided in “mated pairs” to provide redundancy in the event of congestion or failure and to share resources (i.e., load sharing is done automatically). STPs can be arranged in hierarchical levels, to provide hierarchical routing of signaling messages. For example, mated STPs 312 and 316 may be at a first hierarchical level, while other mated STPs may be at a second hierarchical level.

SCPs may provide database functions. SCPs can be used to provide advanced features in an SS7 network, including routing of special service numbers (e.g., 800 and 900 numbers), storing information regarding subscriber services, providing calling card validation and fraud protection, and offering advanced intelligent network (AIN) services. SCP 314 is connected to mated STPs 312 and 316.

In the SS7 network, there are unique links between the different network elements. Table 1 provides definitions for common SS7 links.

TABLE 1

| SS7 link | |
|---|---|
| terminology | Definitions |
| Access (A) | A links connect SSPs to STPs, or SCPs to |
| links | STPs, providing network access and database |
| | access through the STPs. |
| Bridge (B) | B links connect mated STPs to other mated STPs. |
| links | |
| Cross (C) | C links connect the STPs in a mated pair to |
| links | one another. During normal conditions, only |
| | network management messages are sent over C links. |
| Diagonal (D) | D links connect the mated STPs at a primary |
| links | hierarchical level to mated STPs at a |
| | secondary hierarchical level. |
| Extended (E) | E links connect SSPs to remote mated STPs, and |
| links | are used in the event that the A links to home |
| | mated STPs are congested. |
| Fully | F links provide direct connections between local |
| associated | SSPs (bypassing STPs) in the event there is much |
| (F) links | traffic between SSPs, or if a direct connection |
| | to an STP is not available. F links are used |
| | only for call setup and call teardown. |

For a more detailed description of SS7 network topology, the reader is referred to Russell, Travis, Signaling System #7, McGraw-Hill, New York, N.Y. 10020, ISBN 0-07-054991-5, which is incorporated herein by reference in its entirety.

FIG. 4 depicts an exemplary embodiment of a diagram 400 illustrating an exemplary telephony management call forwarding override example. According to an exemplary embodiment, a user on, e.g., but not limited to, a PSTN phone E11 may communicate to server 202 to setup, or override call forwarding setting of various other communications devices associated with the user, such as, e.g., mobile communications device E15, or VoIP device E18. Calls originating from another communications device, such as, e.g., but not limited to, PSTN phone E20, or mobile device E24 and destined for, e.g., but not limited to, mobile device E15, or VoIP device E18, may be rerouted via server 202 to PSTN phone E11. The call setup signalling may be set up via out-of-band (OOB) signaling PPD 100 and may automatically provision the call forwarding from the devices E15, E18.

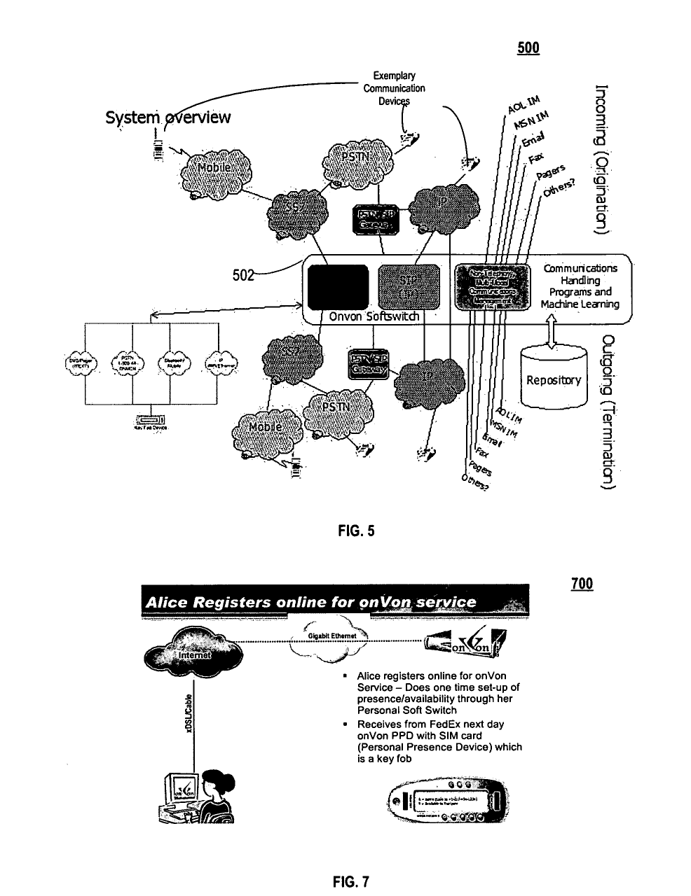

FIG. 5 depicts in an exemplary embodiment, an exemplary embodiment of a system overview 500 of an exemplary system environment whereby a user may be able to manage presence using an OOB PPD 100 according to an exemplary embodiment of the present invention.

System overview 500 may demonstrate exemplary telephone call handling (from origination to termination. The signaling initialization and changes may be handled out-of-band via an exemplary PPD 100. Signaling may occur, e.g., as shown in FIG. 3 in one exemplary embodiment.

In an exemplary embodiment, the system may use artificial intelligence to analyze behavior of the user so as to provide suggested or optimized provision of service.

In another exemplary embodiment, when a user selects a change to presence via PPD 100, the server may provide confirmation to the user of the change of presence.

In one exemplary embodiment, the PPD 100 may communicate over secure communications. In an exemplary embodiment, the communication may be encrypted. In another exemplary embodiment, the communication may require user authentication to ensure the user of the device is the valid user. Various encryption, security, and authentication systems may be used as will be apparent to those skilled in the relevant art.

Diagram 500 may further include multi-mode communication and collaboration. In an exemplary embodiment, various multi-mode communication and collaboration may be handled. In an exemplary embodiment, the present invention may be used to extend call handling to other systems including, e.g., but not limited to, an instant messaging (IM), or an electronic mail (e-mail) system, Paging systems, Fax, etc. An exemplary IM system may include, e.g., but not limited to, an AOL Instant Messenger, an MS Messenger, Yahoo! Messenger, and others.

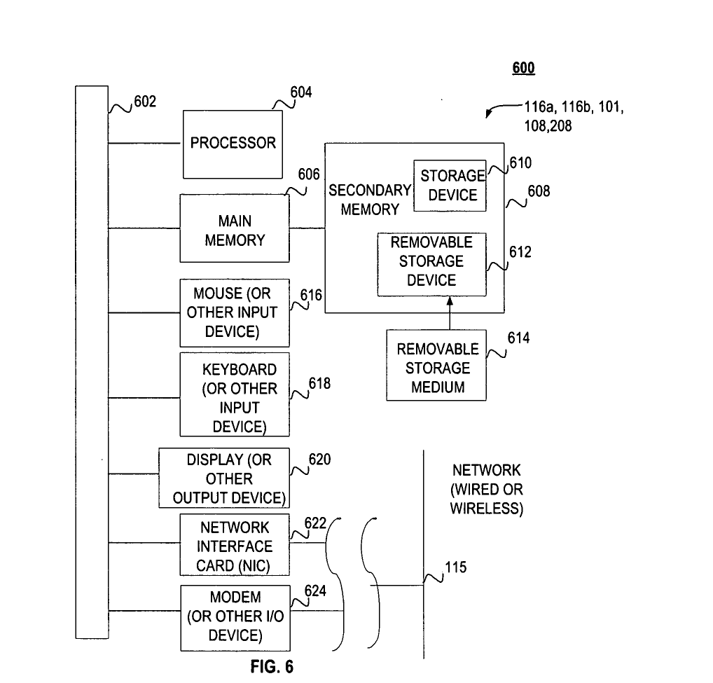

FIG. 6 depicts an exemplary communications or computing device 600 as may be used in various components of the present invention, including, e.g., but not limited to, PPD 100, server 202, etc.

Devices may communicate via a communications link via any of a number of well known protocols such as, e.g., but not limited to, simple mail transport protocol (SMTP), hyper text markup protocol (HTTP), Internet Protocol (IP), transmission control protocol/IP (TCP/IP), etc.

FIG. 6 depicts an exemplary computer system that may be used in implementing an exemplary embodiment of the present invention. Specifically, FIG. 6 depicts an exemplary embodiment of a computer system 600 that may be used in computing devices such as, e.g., but not limited to, client or server, etc. according to an exemplary embodiment of the present invention. FIG. 6 depicts an exemplary embodiment of a computer system that may be used as client device 102, or a server device 104, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 600 is shown in FIG. 6, depicting an exemplary embodiment of a block diagram of an exemplary computer system useful for implementing the present invention. Specifically, FIG. 6 illustrates an example computer 600, which in an exemplary embodiment may be, e.g., (but not limited to) a personal computer (PC) system running an operating system such as, e.g., (but not limited to) MICROSOFT® WINDOWS® NT/98/2000/XP/CE/ME/etc. available from MICROSOFT® Corporation of Redmond, Wash., U.S.A. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 600 is shown in FIG. 6. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 6. Services may be provided on demand using, e.g., but not limited to, an interactive television (iTV), a video on demand system (VOD), and via a digital video recorder (DVR), or other on demand viewing system.

The computer system 600 may include one or more processors, such as, e.g., but not limited to, processor(s) 604. The processor(s) 604 may be connected to a communication infrastructure 606 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 600 may include a display interface 602 that may forward, e.g., but not limited to, graphics, text, and other data, etc., from the communication infrastructure 606 (or from a frame buffer, etc., not shown) for display on the display unit 630.

The computer system 600 may also include, e.g., but may not be limited to, a main memory 608, random access memory (RAM), and a secondary memory 610, etc. The secondary memory 610 may include, for example, (but not limited to) a hard disk drive 612 and/or a removable storage drive 614, representing a floppy diskette drive, a magnetic tape drive, an optical disk drive, a compact disk drive CD-ROM, etc. The removable storage drive 614 may, e.g., but not limited to, read from and/or write to a removable storage unit 618 in a well known manner. Removable storage unit 618, also called a program storage device or a computer program product, may represent, e.g., but not limited to, a floppy disk, magnetic tape, optical disk, compact disk, etc. which may be read from and written to by removable storage drive 614. As will be appreciated, the removable storage unit 618 may include a computer usable storage medium having stored therein computer software and/or data.

In alternative exemplary embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 and interfaces 620, which may allow software and data to be transferred from the removable storage unit 622 to computer system 600.

Computer 600 may also include an input device such as, e.g., (but not limited to) a mouse or other pointing device such as a digitizer, and a keyboard or other data entry device (none of which are labeled).

Computer 600 may also include output devices, such as, e.g., (but not limited to) display 630, and display interface 602. Computer 600 may include input/output (I/O) devices such as, e.g., (but not limited to) communications interface 624, cable 628 and communications path 626, etc. These devices may include, e.g., but not limited to, a network interface card, and modems (neither are labeled). Communications interface 624 may allow software and data to be transferred between computer system 600 and external devices.

In this document, the terms “computer program medium” and “computer readable medium” may be used to generally refer to media such as, e.g., but not limited to removable storage drive 614, a hard disk installed in hard disk drive 612, and signals 628, etc. These computer program products may provide software to computer system 600. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

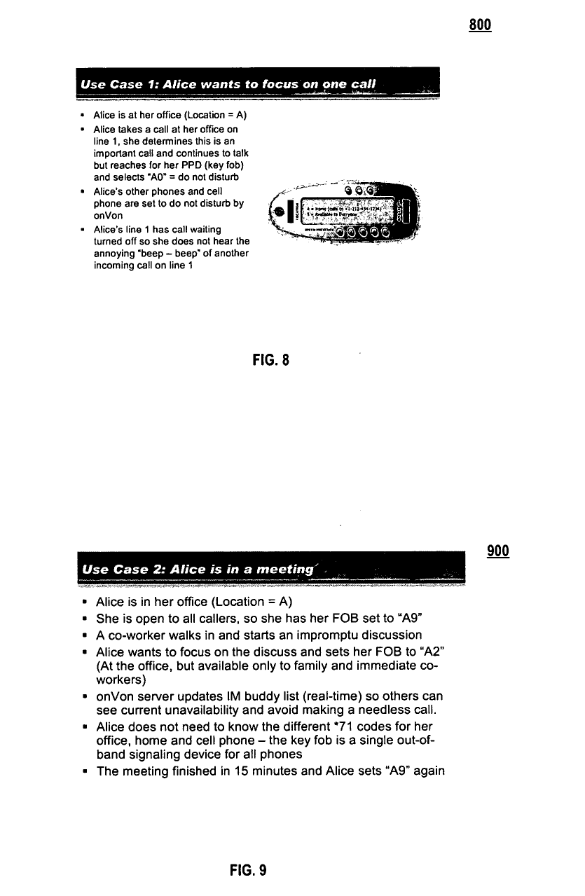

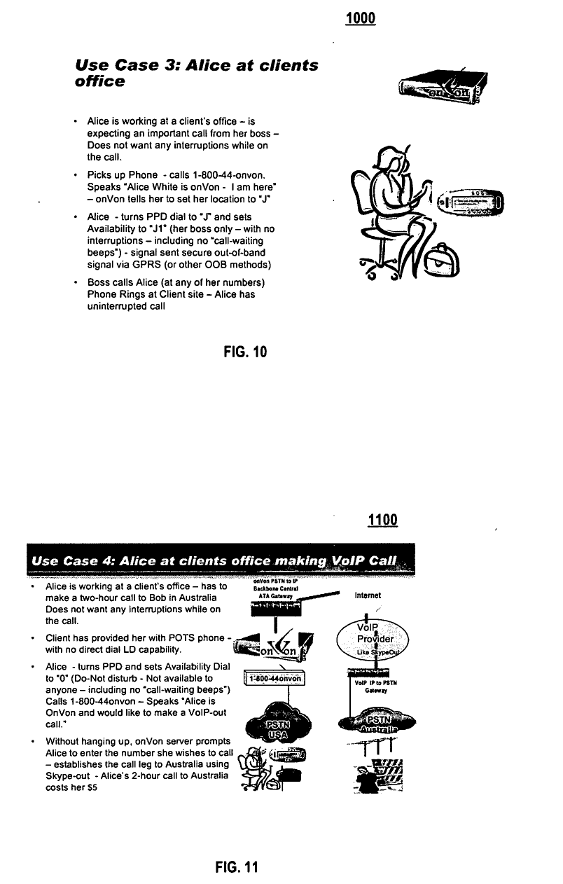

FIG. 7 depicts an exemplary embodiment of a diagram 700 illustrating an exemplary user registration using a PPD 100, which may in one exemplary embodiment be a software application running on a PC allowing setting, and changing of presence by a user.

The database, also referred to as a preference serialization repository, may store meta data about the user. This may include data on, e.g., but not limited to, location, availability and modality preferences and rules.

In an exemplary embodiment, availability, modality and location may be referred to as “Avail, mode, and location” and/or presentity.

An exemplary embodiment of the present invention may include an artificial intelligence (AI) (or machine assisted learning system) to learn (or discern) a user's preferences and rules for call handling based on their interaction with the system. The system may access a database of call handling transactions, and from that learn who calls the user and how the user interacts with the caller such as, e.g., but not limited to, placing in voice mail, accepting calls only during the day, etc. The system may act as an automated administrative assistant or secretary, understanding a user's preferred call routing. The server 202 becomes the AI assistant, able to learn which callers may be important or infer that if we identify someone from a given company as someone on a work list, all email addresses from the domain of that company, appearing in a contact list system may be assigned to a work category, or list. In setup of locations, a location may be home, work, etc., and a list of users' callers may be associated as permitted for availability selection at a particular location and/or availability level.

The intelligent call handling server 202 may in an exemplary embodiment, interact with inbound calls. Further, the server 202 can interact with outbound calls.

Referring to FIG. 5, diagram 500 illustrates another aspect of an exemplary embodiment of the present invention. In an exemplary embodiment, the system 500 may include a database as, e.g., a preference serialization repository. The database, in an exemplary embodiment, may store metadata about the user. Metadata may include, in an exemplary embodiment, for example, but not limited to, information on location, availability and modality preferences and rules. Metadata may also include a contact list, and caller ID parsing data, which may transfer a caller to voicemail (if a user A calls, send the user A to voicemail) or permit the phone to ring, in another exemplary embodiment. Further, metadata may include, e.g., but not limited to, Geo Location information, messaging preferences, and/or information display preferences.

In an exemplary embodiment, geo-location information meta data may be used to determine the position of the caller. In an exemplary embodiment, geo-location information may be obtained from any known positioning system, such as, for example, a global positioning system (GPS). Geo-location information may be used to indicate the coordinates of the user. For example, coordinates obtained from the positioning system may be used to distinguish between work, home, or the client site. The system may use the geo-Location information to apply preferences of the user for that particular location. For example, at the office, the user may screen calls from the user's friends, but may permit the calls when the user is at home.

Meta data may also store information on messaging preferences as part of contact information, in an exemplary embodiment. For example, in an exemplary embodiment, a user may select messaging preferences of the user to indicate that if person X sends an email, the user may send a voicemail and copy or cc the message to person X's email address.

In another exemplary embodiment, meta data may also permit a user to implement information display preferences for the PPD 100 fob display 106 The fob display 106 may present to the user personalized information based on their information display preferences. The user may personalize the user's information display preferences by, for example, selecting favorite weather, news, sports, etc., to be displayed on the fob display 206. Using the information display preferences, the PPD 100 system may use idle packets or extra space to deliver information to the fob PPD 100 device.

Additionally, in an exemplary embodiment, the fob device, PPD 100, or the fob system may also automatically track and predict user preferences regardless of whether the user makes selections indicating their information display preferences. In this exemplary embodiment, the system may use machine assisted learning, which may also be identified as artificial intelligent (AI). According to a user's interaction with the system, the fob device or the fob system may develop and identify the user's preferences and rules for call handling based on their interaction with the system. The system may maintain a data base of call handling transactions. Call handling instructions may be used to identify individuals who call the user and to determine how the user reacts to receiving a call from a particular caller to set up how to interact with all inbound calls and to screen the callers. For example, the system may determine that the user typically sends the call from a particular caller to voice mail, or only takes it during the day, etc. Based on the observed behavior of the user, the system may propose certain provision of services.

In an exemplary embodiment, the system may be able to identify callers of particular importance or to determine that if the user identifies someone from a particular company as being someone on the user's work list, then all emails from that company in the user's contact manager, for example, may be assigned to the work list. Additionally, in an exemplary embodiment, the system may also identify that if someone calls regularly, either from the work list or otherwise, then the system may determine that a caller is important and may enable the caller's calls to go through more readily to the user. For example, if identified as an important caller, a call may be routed to the user even when normally outside a user's presence, such as, for example, when the user is in the car on the way to work, or later at night, etc.

Referring to FIG. 5, in diagram 500, the present embodiment may also be used for processing outbound calls. The fob device, PPD 100, or the fob system may include an executive assistant module. The executive assistant module in an exemplary embodiment may use multi-mode out-of-band (OOB) signaling. The executive assistant module may allow the user to use the PPD 100 key fob to provide a signal to a switch of server 202 handling the call when the call is in progress, to handle the call, or to change the call characteristics (e.g., turn off call waiting, etc.). Using the PPD 100 (the fob), (and the soft keys with the thumb wheels), the fob may signal the switch of server 202 to perform certain functions. The functions may include, e.g., but not limited to, adding another caller, transferring a call, moving a call from land line to cell line, etc. This may be done with the fob display and a code on the fob, using, e.g., buttons and/or selectors 102-112. The fob device may use a softswitch in the hand off of transport, or at the edge of network. Use of a softswitch for setting up transport of a VoIP call will be apparent to those skilled in the relevant art. The fob PPD 100 may perform any functions if it is, for example, an analog telecommunications adapter (ATA) and thus in on the call, or the fob may signal the intelligent call handling server 202 to perform the requested function.

In an exemplary embodiment, modality of communication may refer to a user's selected method of communication with others. A modality of communication may include, e.g., but not limited to, mobile/landline/IP phones, IM, Email, Fax, paging device, etc.

In an exemplary embodiment, PPD 100 may be a fob. In an exemplary embodiment, the PPD 100 may be a small device. The PPD 100 may be of substantially low mass (light weight) and minimal dimensions. In an exemplary embodiment, the PPD 100 may include a mechanism 114 to attach to a key ring. Mechanism 114 may allow a user to consider attaching the PPD 100 to a key ring, thus a key ring fob or a key fob. In an exemplary embodiment, the dimensions may be the width and depth similar to a automobile door opening key ring fob device. In an exemplary embodiment, the length of our fob may be longer than such an automotive fob.

In an exemplary embodiment of the present invention, the system may further include a included a handler, also referred to as a watcher. In another exemplary embodiment, the system may include intelligent learning capability. In an exemplary embodiment, the system may further include a repository, such as a database (db) repository.

In an exemplary embodiment, the PPD 100 device may produce presentity (a source of presence information about a user) which may be transmitted out-of-band to a watcher or watchers of an intelligent call handling presence server.

The AgoVo (previously referred to as onVon) presence servers 202 may maintain information provided by the AgoVo subscriber user via, e.g., a web (or otherwise) provision interface which may be updated with messages from the key fob PPD 100 device.

In an exemplary embodiment, user information (such as, e.g., but not limited to, contacts, etc.) may be uploaded to the server. Such information may be uploaded via, e.g., but not limited to, an applet on a user's machine from, e.g., but not limited to, their contact manager, personal information manager (PIM), such as, e.g., but not limited to, MICROSOFT® OUTLOOK®). In an exemplary embodiment, such information may include, e.g., but not limited to:
Contacts may be automatically (or via, e.g., but not limited to, single-button press) uploaded to, e.g., but not limited to, presence server;
Presence server may stratify contacts based on, e.g., but not limited to, common characteristics (such as, e.g., but not limited to, all emails ending in a particular domain name (e.g., @agovo.com) are work colleagues);
Develop (e.g., but not limited to, suggest) rules to manage calls;
As new contacts get added, e.g., but not limited to, they may be reviewed;
Calendar may be automatically (or, e.g., but not limited to, using a single-button press) may be uploaded to presence server;
Presence server may send notifications and reminders to appointmentss (as may be desired); and/or
Initiate calls to conference call bridges as required.

Calendar information may be used, in an exemplary embodiment, to track with whom a user may be meeting.

The database may be stored on the intelligent call handling presence server 202.

In an exemplary embodiment, the database schema may include, e.g., but not limited to,
First Name, Last Name=character string
SIM (Subscriber Identity Module)=hexadecimal value
Presence entity=“pres:someone@example.com” will be derived from the GSM/GRPS SIM (Subscriber Identity Module)
timestamp=last communication YYYY-MM-DD-HH-MM-SS-MMM
last web access=YYYY-MM-DD-HH-MM-SS-MMM
last web update=YYYY-MM-DD-HH-MM-SS-MMM
sequence=numbered messages from key fob to watcher
status=open, closed
location=A, B, . . .
availability=0, 1, 2, . . .
modality=POTS, EMAIL, SMS, VoIP, . . .
contact priority=9.9
contact methods=home, office, cell, . . . email, SMS, IM
note=any textual message . . . “I'm in NYC next week”
who-can-see-me-where=contacts who can see my location
who-can-see-me-how=contacts who can see my method of access

While various exemplary embodiments of the present invention have been described above, it should be

TABLE 2

| Term | Definition |
|---|---|
| access tandem | An AT is a class 3/4 switch used to switch |
| (AT) | calls between EOs in a LATA. An AT provides |
| | subscribers access to the IXCs, to provide |
| | long distance calling services. An access |
| | tandem is a network node. Other network nodes |
| | can include, for example, a CLEC, or other |
| | enhanced services provider (ESP), an |
| | international gateway or global point-of- |
| | presence (GPOP), or an intelligent |
| | peripheral(IP). |
| bearer (B) | Bearer (B) channels are digital channels |
| channels | used to carry both digital voice and |
| | digital data information. An ISDN bearer |
| | channel is 64,000 bits per second, which |
| | can carry PCM-digitized voice or data. |
| called party | The called party is the caller receiving a |
| | call sent over a network at the destination |
| | or termination end. |
| calling party | The calling party is the caller placing a |
| | call over any kind of network from the |
| | origination end. |
| central office | A CO is a facility that houses an EO homed. |
| (CO) | EOs are often called COs. |
| class 1 switch | A class 1 switching office, the Regional |
| | Center(RC), is the highest level of local and |
| | long distance switching, or “office of last |
| | resort” to complete a call. |
| class 3 switch | A class 3 switching office was a Primary |
| | Center (PC); an access tandem (AT) has |
| | class 3 functionality. |
| class 4 switch | A class 4 switching office was a Toll Center |
| | (TC) if operators were present or else a Toll |
| | Point (TP); an access tandem (AT) has class 4 |
| | functionality. |
| class 5 switch | A class 5 switching office is an end office |
| | (EO) or the lowest level of local and long |
| | distance switching, a local central office. |
| | The switch closest to the end subscriber. |
| competitive LEC | CLECs are telecommunications services |
| (CLEC) | providers of local services that can compete |
| | with ILECs. !nterprise and Century 21 are |
| | examples. A CLEC may or may not handle |
| | IXC services as well. |
| competitive access | Teligent and Winstar are examples. |
| providers (CAPS) | |
| customer premises | CPE refers to devices residing on the premises |
| equipment (CPE) | of a customer and used to connect to a telephone |
| | network, including ordinary telephones, key |
| | telephone systems, PBXs, video conferencing |
| | devices and modems. |
| digitized data | Digitized data refers to analog data that has |
| (or digital data) | been sampled into a binary representation (i.e., |
| | comprising sequences of 0's and 1's). Digitized |
| | data is less susceptible to noise and |
| | attenuation distortions because it is more |
| | easily regenerated to reconstruct the |
| | original signal. |
| egress end office | The egress EO is the node or destination EO |
| | with a direct connection to the called party, |
| | the termination point. The called party is |
| | “homed” to the egress EO. |
| egress | Egress refers to the connection from a called |
| | party or termination at the destination end |
| | of a network, to the serving wire center (SWC). |
| end office (EO) | An EO is a class 5 switch used to switch local |
| | calls within a LATA. Subscribers of the LEC are |
| | connected (“homed”) to EOs, meaning that |
| | EOs are the last switches to which the |
| | subscribers are connected. |
| Enhanced Service | A network services provider. |
| Provider (ESP) | |
| equal access | 1+ dialing as used in US domestic calling for |
| | access to any long distance carrier as required |
| | under the terms of the modified final judgment |
| | (MFJ) requiring divestiture of the Regional Bell |
| | Operating Companies (RBOCs) from their parent |
| | company, AT&T. |
| global point of | A GPOP refers to the location where |
| presence | international telecommunications facilities |
| (GPOP) | and domestic facilities interface, an |
| | international gateway POP. |
| incumbent LEC | ILECs are traditional LECs in the US, which |
| (ILEC) | are the Regional Bell Operating Companies |
| | (RBOCs). Bell South and US West are |
| | examples. ILEC can also stand for an |
| | independent LEC such as a GTE. |
| ingress end office | The ingress EO is the node or serving wire |
| | center (SVC) with a direct connection to |
| | the calling party, the origination point. |
| | The calling party is “homed” to the |
| | ingress EO. |
| ingress | Ingress refers to the connection from a |
| | calling party or origination. |
| integrated service | An ISDN Basic Rate Interface (BRI) line |
| digital network | provides 2 bearer B channels and 1 data D |
| (ISDN) basic rate | line (known as “2B + D” over one |
| interface | or two pairs) to a subscriber. |
| (BRI) line | |
| integrated | ISDN is a network that provides a standard |
| services | for communications (voice, data and signaling), |
| digital network | end-to-end digital transmission circuits, |
| (ISDN) | out-of-band signaling, and a features |
| | significant amount of bandwidth. |
| inter machine | An inter-machine trunk (IMT) is a circuit |
| trunk (IMT) | between two commonly-connected switches. |
| inter-exchange | IXCs are US domestic long distance |
| carrier (IXC) | telecommunications services providers. |
| | AT&T, MCI, Sprint, are examples. |
| internet | IP is part of the TCP/IP protocols. It is used |
| protocol (IP) | to recognize incoming messages, route outgoing |
| | messages, and keep track of Internet node |
| | addresses (using a number to specify a |
| | TCP/IP host on the Internet). IP corresponds |
| | to the network layer of OSI. |
| Internet service | An ISP is a company that provides Internet |
| provider (ISP) | access to subscribers. |
| ISDN primary rate | An ISDN Primary Rate Interface (PRI) line |
| interface (PRI) | provides the ISDN equivalent of a T1 circuit. |
| | The PRI delivered to a customer's premises can |
| | provide 23B + D (in North America) or 30B + |
| | D (in Europe) channels running at 1.544 |
| | megabits per second and 2.048 megabits per |
| | second, respectively. |
| local exchange | LECs are local telecommunications services |
| carrier (LEC) | providers. Bell Atlantic and US West are |
| | examples. |
| local access and | A LATA is a region in which a LEC offers |
| transport area | services. There are over 160 LATAs of these |
| (LATA) | local geographical areas within the |
| | United States. |
| local area | A LAN is a communications network providing |
| network (LAN) | connections between computers and peripheral |
| | devices (e.g., printers and modems) over a |
| | relatively short distance (e.g., within a |
| | building) under standardized control. |
| modified final | Modified final judgment (MFJ) was the decision |
| judgment (MFJ) | requiring divestiture of the Regional Bell |
| | Operating Companies (RBOCs) from their parent |
| | company, AT&T. |
| network node | A network node is a generic term for the |
| | resources in a telecommunications network, |
| | including switches, DACS, regenerators, etc. |
| | Network nodes essentially include all non- |
| | circuit (transport) devices. Other network |
| | nodes can include, for example, equipment of |
| | a CLEC, or other enhanced service provider |
| | (ESP), a point-of-presence (POP), an |
| | international gateway or global point-of- |
| | presence (GPOP). |
| new entrant (NE) | A new generation global telecommunications. |
| next generation | A new telecommunications services provider, |
| telephone (NGT) | especially IP telephony providers. Examples |
| | are Level 3 and Qwest. |
| packetized | One example of packetized voice is voice over |
| voice or | internet protocol (VOIP). Voice over packet |
| voice over a | refers to the carrying of telephony or voice |
| backbone | traffic over a data network, e.g. voice over |
| | frame, voice over ATM, voice over Internet |
| | Protocol (IP), over virtual private networks |
| | (VPNs), voice over a backbone, etc. |
| Pipe or | A pipe or dedicated communications facility |
| dedicated | connects an ISP to the internet. |
| communications | |
| facility | |
| point of | A POP refers to the location within a LATA |
| presence | where the IXC and LEC facilities interface. |
| (POP) | |
| point-to-point | A virtual private networking protocol, point- |
| tunneling | to-point tunneling protocol (PPTP), can be |
| protocol | used to create a “tunnel” between a |
| (PPTP) | remote user and a data network. A tunnel |
| | permits a network administrator to extend a |
| | virtual private network (VPN) from a server |
| | (e.g., a Windows NT server) to a data |
| | network (e.g., the Internet). |
| point-to- | PPP is a protocol permitting a computer to |
| point (PPP) | establish a connection with the Internet using |
| protocol | a modem. PPP supports high-quality graphical |
| | front ends, like Netscape. |
| postal telephone | State regulated telephone companies, many of |
| telegraph (PTT) | which are being deregulated. NTT is an example. |
| private branch | A PBX is a private switch located on the |
| exchange (PBX) | premises of a user. The user is typically a |
| | private company which desires to provide |
| | switching locally. |
| private | A private line is a direct channel specifically |
| line with a | dedicated to a customer's use between two |
| dial tone | specificed points. A private line with a dial |
| | tone can connect a PBX or an ISP's access |
| | concentrator to an end office (e.g. a |
| | channelized T1 or PRI). A private line can also |
| | be known as a leased line. |
| public switched | The PSTN is the worldwide switched voice |
| telephone | network. |
| network | |
| (PSTN) | |
| regional Bell | RBOCs are the Bell operating companies |
| operating | providing LEC services after being divested |
| companies | from AT&T. |
| (RBOCs) | |
| signaling | SS7 is a type of common channel interoffice |
| system 7 | signaling (CCIS) used widely throughout the |
| (SS7) | world. The SS7 network provides the signaling |
| | functions of indicating the arrival of calls, |
| | transmitting routing and destination signals, |
| | and monitoring line and circuit status. |
| switching | An office class is a functional ranking of a |
| hierarchy | telephone central office switch depending on |
| or office | transmission requirements and hierarchical |
| classification | relationship to other switching centers. Prior |
| | to AT&T's divestiture of the RBOCs, an office |
| | classification was the number assigned to |
| | offices according to their hierarchical |
| | function in the U.S. public switched network |
| | (PSTN). The following class numbers are |
| | used: class 1 = Regional Center(RC), |
| | class 2 = Sectional Center (SC), class |
| | 3 = Primary Center (PC), class 4 = |
| | Toll Center (TC) if operators are |
| | present or else Toll Point (TP), class |
| | 5 = End Office (EO) a local central |
| | office. Any one center handles traffic from |
| | one to two or more centers lower in the |
| | hierarchy. Since divestiture and with more |
| | intelligent software in switching offices, |
| | these designations have become less firm. |
| | The class 5 switch was the closest to the |
| | end subscriber. Technology has distributed |
| | technology closer to the end user, diffusing |
| | traditional definitions of network switching |
| | hierarchies and the class of switches. |
| telecommunications | A LEC, a CLEC, an IXC, an Enhanced Service |
| carrier | Provider (ESP), an intelligent peripheral |
| | (IP), an international/global point-of- |
| | presence (GPOP), i.e., any provider of |
| | telecommunications services. |
| transmission | TCP is an end-to-end protocol that operates |
| control | at the transport and sessions layers of |
| protocol (TCP) | OSI, providing delivery of data bytes |
| | between processes running in host computers |
| | via separation and sequencing of IP packets. |
| transmission | TCP/IP is a protocol that provides |
| control | communications between interconnected |
| protocol/internet | networks. The TCP/IP protocol is widely |
| protocol (TCP/IP) | used on the Internet, which is a network |
| | comprising several large networks |
| | connected by high-speed connections. |
| trunk | A trunk connects an access tandem (AT) |
| | to an end office (EO). |
| wide area network | A WAN is a data network that extends a LAN over |
| (WAN) | the circuits of a telecommunications carrier. |
| | The carrier is typically a common carrier. A |
| | bridging switch or a router is used to connect |
| | the LAN to the WAN. |

Further exemplary embodiments of the present invention are further described below by way of example only, and not limitation.

Exemplary Use Cases

1. Call Filter by Availability

According to an exemplary embodiment, the user may be provided the ability to change the user's availability using the keyVob device to change from, e.g., A9 to A0 which may mean to send all calls to Voice Mail (VM), for example. According to an exemplary embodiment, the feature may be also called “Instant Do Not Disturb (DND).” According to an exemplary embodiment, the user may take an important call on her desk phone and may want to shut down all other callers. The user may use the keyvob to dial A0. According to an exemplary embodiment, the user may be provided a preprogrammed instant DND button on the keyVob making this only one button to press. According to an exemplary embodiment, any other incoming calls may be sent to VM. According to an exemplary embodiment, the user may be provided confirmation on the display of settings (A0). According to an exemplary embodiment, calls may be sent to one voice mail (may interface with existing VM).

2. Call Filters by Levels

According to an exemplary embodiment, the user may be in her office and a co-worker may stop by her desk to chat. According to an exemplary embodiment, the user may use her keyVob to change from A9 to A4. A9 may take all callers. A4 may take calls from only other co-workers, spouse, etc., according to an exemplary embodiment. Exemplary displays may include: Displays A9=Accept all Calls; Displays A4=Coworkers Only; and Rotary dial.

3. Redefinition of Location

According to an exemplary embodiment, the user may be working at a client's site and may wish to redefine the user location. The user may dial 1-800-AGOVO and may identify the user by, e.g., but not limited to, touchtone password, etc., and may add the client's phone as a new location. For example, the feature in an exemplary embodiment, may not be available by voice recognition. In an exemplary embodiment, the feature may include a location J=212-555-1212. The user may say the call in number, use this or new number. In an exemplary embodiment, the Now location J may be made available on the keyvob device to re-direct calls. According to an exemplary embodiment, the feature may provide redefinition of location. In an exemplary embodiment, this feature may be customized or initiated from a website.

4. Call Redirect in a Call

According to an exemplary embodiment, the user may be at home and may take an incoming call on her cell phone from Bob. According to an exemplary embodiment, the user, two minutes into the call on her cell phone, may realize this will be a 45 minute call, she also may see her cell battery power is low. According to an exemplary embodiment, the user may tell Bob she wants to change handsets. According to an exemplary embodiment, the user may use the keyvob to signal to park her current call and may re-direct to her home phone. On the keyvob she may press MENU>REDIRECT>B. When moving location A>B, the user may be prompted to say “you have an open call, do you want to transfer this call?” Agovo may place her cell call on hold, her home phone may ring—Alice may be talking again to Bob.

5. Click to Call (Dialer to a Buddy)

According to an exemplary embodiment, the user may use the keyVob to click to call Bob. According to an exemplary embodiment, the user may press MENU>CLICK-TO-CALL>DIRECTORY>BOB. According to an exemplary embodiment, the user may be prompted CALL FROM WHERE>A. According to an exemplary embodiment, the user's desk phone may ring, voice says “This is Agovo, standby for second call leg setup”. According to an exemplary embodiment, the Agovo softswitch may call Bob, and may join the calls. According to an exemplary embodiment, the user may talking to Bob from her Office phone

6. Show Your Presence to Your Buddy list

In an exemplary embodiment, the user may allow certain users in her buddy list to see her availability on the Agovo website. In an exemplary embodiment, the user may approve friends of the user may be allowed to login to the Agovo Presence Server and display the user's presence.

7. Voice Over IP Bridging

In an exemplary embodiment, the user may be at her desk, she may want to make a long distance call to a co-worker. The user may call the Agovo Softswitch and may say “Give me a VONAGE line for my outgoing calls”. The Agovo Softswitch may give the user her VoIP dialtone (or corporate dial-tone or other lowest cost network dial-tone. Combined Features may include: Click to call Bob from the Office (A) via VONAGE; MENU>CLICK-TO-CALL>DIRECTORY>BOB>VIA>VONAGE.

7A. Outgoing Call Line Selection

In an exemplary embodiment, the user may be driving, she may want to make a long distance call to a co-worker in Australia. The user may use the keyfob to click . . . Call TO, Call FROM, with Call VIA . . . Summary: On the keyfob . . . MENU>CLICK-TO-CALL>CALL FROM>Cell; CALL TO>DIRECTORY>BOB;CALL VIA>VONAGE. A call leg may be established to the user's cell. A call leg may be established to Bob via Vonage. The user may talk to Bob via Vonage (avoiding expensive mobile long distance rates).

8. Rescue Call/Wake-Up—Notice Call

In an exemplary embodiment, the user may call the Agovo Softswitch and may request an incoming ring and/or vibrate on the Agovo keyVob. This feature can also be triggered via SMS, for example, but not limited to. The callback can be immediate or delayed. In an exemplary embodiment, the user may use this feature to end a meeting which is going too long: Alice may use the keyVob to press the preprogrammed instant button “RingMe my current location in 2 Minutes”. In an exemplary embodiment, the user may also use MENU>CALL-BACK>WHEN>0,1,2,3 minutes>WHERE>A (cell, office, home). This feature may be used as a “Rescue Call” to end a meeting. In an exemplary embodiment, the call can be driven by Calendar to Notify of a Schedule or Wake-Up Call. In an exemplary embodiment, the user may by ringing the keyVob find his or her keys. In an exemplary embodiment, the user may redefine buttons as soft keys.

10. Show Number of Pending Voice Messages

In an exemplary embodiment, the user may press the keyVob to show the number of voice mails pending. The PPD 100 may display who, what, when . . . . In an exemplary embodiment, the user may select message polling by pressing for a query, rather than constant updating.

11. Break Thru Caller

In an exemplary embodiment, the user may be an Agovo keyVob user, Dave is the user's boss. Dave calls the user. In an exemplary embodiment, the user may define a break thru list the user may define with the web interface. In an exemplary embodiment, the user may create a keyVob to keyVob Instant Message. Alternatively, in an exemplary embodiment, the user may give important people the ability to enter, e.g., a touch tone code at the end of the user's phone number (e.g.902-555-1234*123) to get through even though the called party might not be in your current availability group. As an example, the user's daughter may call the user from a phone without caller ID—the user would want her to get through to the user but the service has no way to know it's her—she can enter a code the user may have given her beforehand (e.g., during the call or possibly when she gets the user's voice mail) to let the system know the user wants the call to go through. This feature is an alternative to call the person in the next cubicle and say “Ask Alice to call me”.

12. Presence Confirmation

According to an exemplary embodiment, presence may be confirmed to an Agovo device upon setting (Web/Phone or KeyFob). According to an exemplary embodiment, an indication of confirmation may include, e.g., but not limited to, a vibration, a ring-tone, a flash of the light, et cetera.

13. Voice Mail Greeting change

According to an exemplary embodiment, the may have the ability to pre-record multiple personal voice mail greetings. For example, but not limited to, the user may select “I just stepped out of office for 10 minutes,” “it's Monday blah blah blah,” “it's Tuesday blah blah I'm unavailable—please call 555-1212 and Chuck will help you,” and/or a group of standard greetings that may come from which the Agovo service users may choose. In an exemplary embodiment, the user may quickly and easily change/toggle these messages using the menu key and dials on the keyVob or phone/PDA software as needed.

Outlook—Calendar Management

According to an exemplary embodiment, a calendar may be automatically (or single-button press) uploaded to a presence server. The presence server may send notifications and reminders to appointments (as desired). According to the exemplary embodiment, the user may initiate calls to conference call bridges as required.

Presence Server—Machine Learning

According to the exemplary embodiment, the presence server may be provided machine learning based upon contact information and user call handling patterns (sending call to VM allowing caller through). According to an exemplary embodiment, additional call handling rules can be derived. According to the exemplary embodiment, rules can be forwarded to the KeyVob and/or a Web server to approve.

Video Service Control

The PPD 100 device, according to an exemplary embodiment, may be used as a remote programmer for a personal video recorder (PVR) or digital video recorder (DVR). For example, if a user is talking to a friend about a new show, the user could set it to be recorded on a DVR or PVR.

The PPD 100 device, according to another exemplary embodiment, may be used for re-broadcasting. According to an exemplary embodiment, a user is visiting a friend (or at work . . . or where the user has a browser, such as, e.g., an internet browser, and no television(TV) and the user wants to access stored content, e.g,. on a DVR or PVR (previously recorded, or on demand), remotely. Then, in an exemplary embodiment, the user may direct the user's DVR/PVR to stream the previously recorded (or on demand) content to a Web-Browser (e.g. the user may be traveling, but does may not want to watch the local news).

The PPD 100 device, according to yet another exemplary embodiment, may be used with an Interactive television (iTV) or receiver device. In an exemplary embodiment, the user may wish to request to purchase something shown in a commercial or in programming (e.g., the user may select a prompt to “send me info on a particular vehicle such as, e.g., a pickup truck). Various conventionally known interactive television functionalities may combined with the present invention to achieve further features of the present invention.

Regarding TV options, the personal presence device 100 keyfob may control the type/source of 2-way TV messages, according to an exemplary embodiment. In a 2-way Internet Protocol (IP) TV environment, a person can “click” to indicate “please send me more information on that Ford F-150.” In an exemplary embodiment, the user may control who and/or when a third party can contact or send a message to the user.

In a converged TV and communications environment, according to an exemplary embodiment of the invention, a TV may accept a phone call, making the TV the recipient of a regular or video call to telephone number of the user. The interactive television may include display of caller ID information on the TV. In an exemplary embodiment, the PVRIDVR may automatically pause to give the user an opportunity to answer the call without missing programming.

According to an exemplary embodiment, the user may have the choice of accepting the call on the TV while pausing video programming (thus the user can manage presence or the user's willingness to accept a call based on the importance of the programming—i.e., never, ever interrupt the SUPERBOWL!).

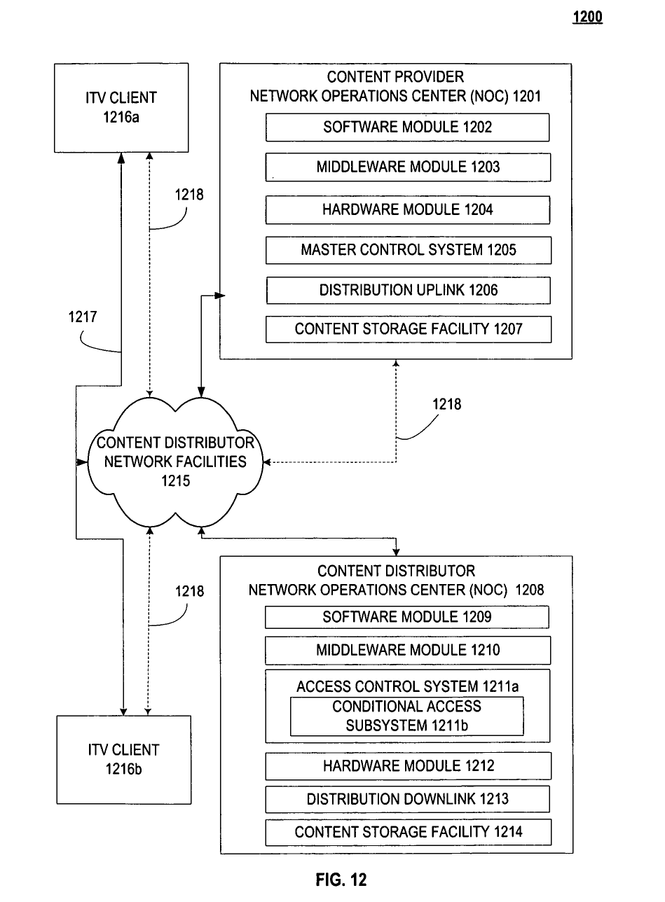

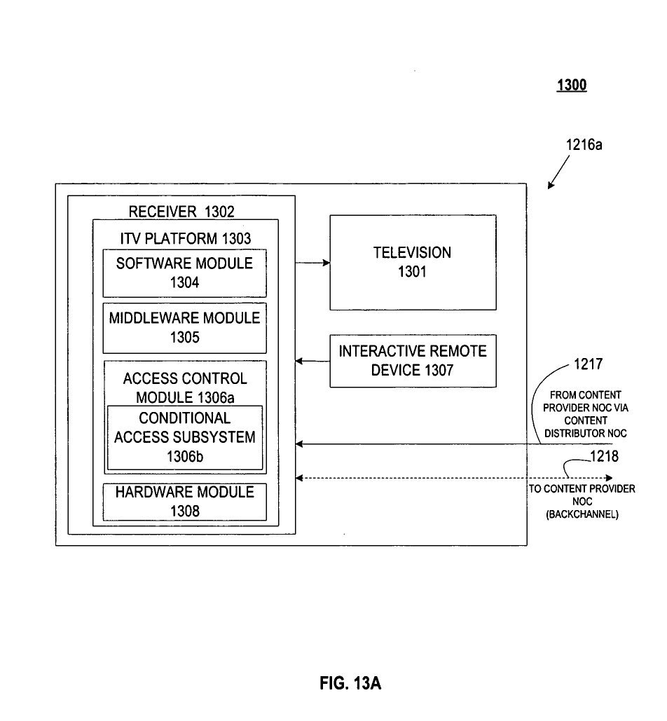

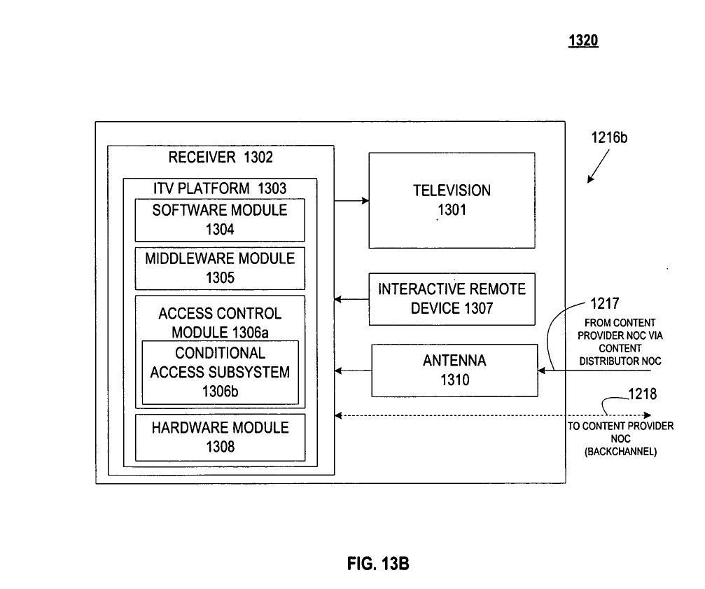

For further information regarding ITV, see the ITV overview below with reference to FIGS. 12 and 13.

Receiving phone calls on the TV, according to an exemplary embodiment may simply be an extension of the user's home number, or may be an alternate number (or IP address) to establish a video conference.

The PPD 100 device, according to an exemplary embodiment, may be used for VideoConferencing via television (TV) call control. Availability may vary based upon a user's watching habits.

The PPD 100 device, according to an exemplary embodiment, may be used for remote surveillance. In an exemplary embodiment, remote security watching may be enhanced with the PPD 100. In an exemplary embodiment, the user may have security cameras installed. For example, the user may be out for an evening, and a babysitter may be at home. The user may monitor the user's kids (and their caretaker) from wherever the user is (or even set up a stream to the user's video enabled phone). Similarly, in another exemplary embodiment, for day care providers, the user may also review/surveil using installed cameras.

Interactive Television Overview

FIG. 12 depicts an exemplary embodiment of the invention where the PPD 100 may be adapted to communicate with an interactive television (ITV) environment 1200 using signaling. The PPD 100 of an exemplary embodiment of the present invention, although described below in a particular environment, may be implemented, as previously noted, in a variety of other environments.

ITV environment 1200 in an exemplary embodiment may include a content provider network operation center (NOC) 1201, a plurality of ITV clients 1216a, 1216b, etc. and a content distributor NOC 1208. The content provider NOC 1201, ITV clients 1216a-b, and content distributor NOC may be coupled to one another by content distributor network facilities 1215 or other coupling device. The ITV environment 1200 of FIG. 12 also illustrates, in an exemplary embodiment, a distribution channel 1217 that may be used to broadcast content to the ITV clients 1216a, 1216b from the content providers over the content distribution network 115, and a backchannel 1218 that may be used to receive interactive responses from the ITV clients 1216a, 1216b at, e.g., the content provider. The back channel 1218 may be in an inband, or out-of-band channel. The back channel 1218 may be separate from the distribution channel 1216. The back channel 1218 may use circuit connections, or packet switched communication.

Content provider NOC 1201 may include, e.g., a software module 1202 and a middleware module 1203 running on top of a hardware module 1204. The hardware module 1204 may include, e.g., a processor and associated memory. The content provider NOC 1201 may also include a master control system 1205 that may be used to assemble portions of programming service content for distribution. The portions of programming service content may be accessed using various known methods from a content storage facility 1207, onto which the content may have been previously stored. The content provider NOC 1201 may also include a distribution uplink 106 that may be used to upload content to the content distributor for distribution to ITV clients 1216a, 1216b, etc. Of course, the content provider in another exemplary embodiment, may communicate directly with ITV clients 1216a, 1216b. For example, the clients 1216a, 1216b, etc. may communicate via a communications link directly to the content provider via a protocol such as, e.g., but not limited to, simple mail transport protocol (SMTP), hyper text markup protocol (HTTP), simple message system (SMS), Internet relay chat, etc.

Content distributor NOC 1208 may include a software module 1209, a middleware module 1210, and an access control system 1211a including, e.g., a conditional access subsystem 1211b, running on a hardware module 1212. A distribution downlink 1213 can be used, in an exemplary embodiment, to download content from the content providers to the content distributor NOC 1208, for temporary storage in content storage facility 1214, prior to distribution directly to, or via the content distributor network 1215, to ITV clients 1216a, 1216b for viewing by viewers.

As shown in the exemplary block diagram 1300 in FIG. 13A, ITV client 1216a may include, in an exemplary embodiment, a television 1301, a receiver 1302, and an interactive remote device 1307 such as a remote control. Receiver 1302 can include, in an exemplary embodiment, ITV platform 1303 that can include, e.g., a software module 1304, a middleware module 1305, an access control module 1306a including, e.g., a conditional access subsystem 1306b (such as a smart card), and hardware module 1308. The hardware module 1308 may include a processor and associated memory. The various modules may be combined into a set-top box. The set-top box may be configured to record programming services. As shown in FIG. 13A, receiver 1302 can be configured to receive content from content provider NOC 1201 via, e.g., a content distributor network 1215 and content distributor NOC 1208, or directly via interface equipment, for example. The ITV platform 1303 of FIG. 13A can be thought of as an example environment that could be used for a content distributor that uses a cable television (CATV) network. Content may be distributed to ITV 1216a, 1216b, etc. from the content provider over content distributor facilities as shown in line 1217. Dotted line 1218 may represent an exemplary back channel 1218 for sending interactive information to the content provider. The back channel is typically provided via a phone modem or via access to a broadband network.

Alternatively, as is shown in the exemplary embodiment of block diagram 1320, in FIG. 13B, receiver 1302 can be configured to receive content from content provider NOC 1201 via content distributor network 1215 and content distributor NOC 1208 via antenna 1310, such as a satellite dish or the like.

The interactive television system described herein is exemplary only, and non-limiting. The invention can also be implemented in many other types of interactive systems. For example, the content provider may communicate directly with the ITV clients 1216a. Programming services, video and interactive television content may be provided directly to the viewer. Also, a back channel may be provided directly from the ITV client 1216a to the content provider, without passing through a content distributor. A back channel is not necessary in all embodiments of the invention.

As will be understood by a person having ordinary skill in the art, content provider NOC 1201 can distribute content via distribution uplink 1206 to content distributor NOC 1208. Content distributor NOC 1208 can receive the content from content provider NOC 1201 via distribution downlink 1213. Content distributor NOC 1208 can then distribute content to ITV clients 1216a, 1216b through content distributor network facilities 115. Examples of content distributors include, e.g., COMCAST CORPORATION of Philadelphia, Pa., USA, DIRECTV of El Segundo, Calif. USA, ECHOSTAR COMMUNICATIONS CORPORATION of Englewood, Colo., USA, and TIME WARNER CABLE of Stamford, Conn. USA. Conventionally, content may be distributed over various network platform types including voice, data, cable television (CATV), wireless communications networks, direct broadcast satellite television, multichannel multipoint distribution service (MMDS) and wireless fidelity (WI-FI).

The content provided to the ITV clients 1216A may include a number of channels, such as broadcast network channels, cable channels, subscription channels, etc. These types of channels may be referred to as linear channels. Other types of programming services may also be provided, such as, e.g., on demand services. Exemplary forms of on demand services include, e.g., but are not limited to, a video on demand (VOD) service, a subscription VOD (SVOD) service, etc. Other on demand services may include any of various digital video recorder (DVR) offerings by which a viewer can record and view digital video content. An exemplary programming service program may include, e.g., a movie, or a series, that may be made available by a programming service such as, e.g., CBS, ABC, NBC broadcasting programming services, or pay services like SHOWTIME or HBO. Programs may also include, e.g., high definition (HD) programs, VOD and SVOD programs, and programs stored on DVRs. Viewers that have advanced set top boxes may be able to access robust digital video recording and playback capabilities.

Conference Call Set-Up

The PPD 100 device, according to another exemplary embodiment, may be used to eliminate the need for inbound conference call bridges. According to an exemplary embodiment, the user could see if others were not busy, and then using one number (or a Global Unique Identifier (GUID)) could reach the others, the Agovo service provider according to the present invention, may control all the access to the user, (where the user is, and at which number).

Music

The PPD 100 device, according to another exemplary embodiment, may be used to acquire play lists from, e.g., but not limited to, radio stations (in exchange for a portion of the revenues) and then if a user sends a request (such as, e.g., to buy/bookmark this song) to the server, the user may enter the station the user is listening to, and based on a timestamp would know by comparing the timestamp of station to what was being played, and could determine what was being played at that time. The music server according to an exemplary embodiment of the present invention, could send an email, or store on a website information to allow a later purchase.

The PPD 100 device, according to another exemplary embodiment, may be used for streaming. If the user had a computer loaded with digital content files, such as, e.g., but not limited to, Mp3s (and the computer is set up with software according to an exemplary embodiment of the present invention, (at the user's home)), a service provider, according to an exemplary embodiment could stream songs to the user's computer at work (for playing) and/or to a web device (similar to TV or DVD videos, discussed above). The service provider, in an exemplary embodiment, may merely send a streaming control signal to the computer to cause streaming to start.

The PPD 100 device, according to another exemplary embodiment, may be used for providing ambient music. According to an exemplary embodiment, if the user has a media center type computer (e.g., a computer equipped with audio and/or video capture and output capabilities) (an exemplary embodiment may include a device from Streetfire Sound Labs, of 340 Brannan Street, Suite 300, San Francisco, Calif. 94107) or SONOS Incorporated, of 223 E.De La Guerra Street, Santa Barbara, Calif., 93101. The device may be an embedded Linux box hooked up to 2 jukeboxes with 700 CD slots. The user can control where the music goes, what play lists play, etc. Thus, ambient music may be played and controlled by PPD 100.

The PPD 100 device, according to another exemplary embodiment, may be used to control satellite music. In an exemplary embodiment, the present invention may pull down play lists, and may use the PPD 100 device to, e.g., but not limited to, set channels, figure out what was played that the user liked, etc.

Ambient Devices

The PPD 100 device, according to another exemplary embodiment, may be used to control information flows via, e.g., but not limited to, a separate datacast network to, e.g., but not limited to, a user's ambient display devices in the room. If the user has display devices receiving data via, e.g., but not limited to, a data casting network (an exemplary embodiment may include a device from Ambient Devices of One Broadway, 14^{th} Floor, Kendall Square, Cambridge, Mass. 02142), then the device may change information to be displayed and/or cause different information to be appear on the user's display (i.e. ambient) device via the PPD 100 device.

In another exemplary embodiment call creation may include, e.g., but not limited to, (auto select parties and way to connect (via VoIP) and may press go and all may be set up.

Previous references to ONVON and GIZVO have been revised to reflect AGOVO and KeyFob or KeyVob. The KeyVob is a handheld device such as, e.g., a fob to which keys may be attached. The device may be approximately 2 inches to 2.5 inches.

Remote (Home Entertainment)

The PPD 100 device, according to another exemplary embodiment, may be used as a universal remote control. Software is available today to modify a PDA to act as a universal remote. According to an exemplary embodiment, the PPD 100 device may be used to obtain metadata about TV shows, the CDs in a player (or jukebox) etc).

Home Automation

The PPD 100 device, according to another exemplary embodiment, may be used in junction with home automation control systems as a remote control There are various home automation control systems (based upon the well known ×10 standard) that may be remotely controlled. Thus, the PPD 100 may be used to send a message (e.g., “I am coming home early today, please warm up the house,” “Honey—The Iron and Stove are OFF”).

Home Telephony

The PPD 100 device, according to another exemplary embodiment, may be used to control home telephones (much the way a home private branch exchange (PBX) may do so) via the PPD 100 device. The PPD 100 device may enable, e.g., but not limited to, call routing, call handling, parking etc. all on either one twisted pair and/or on two twisted pair. According to an exemplary embodiment, there may be a small box attached to each phone (which may look like a DSL line filter) that may be controlled by the PPD 100, also known as the AGOVO KeyVob™ or a home AgoVo telephony device according to exemplary embodiments of the present invention. A call may come in, that the user could have set up (via, e.g., the web), and the call may go to the phone at which you are located (and only that phone may ring). According to an exemplary embodiment, the system may include a way to identify the user location. In an exemplary embodiment, any of various well known methods to determine a user location may be used. For example, in an exemplary embodiment, the location of the user may be determined by, e.g., but not limited to, use of a radio frequency identification tag (RFID). The user's location may alternatively be determined, by user keying, or entry on the PPD 100. According to an exemplary embodiment, by adding an exemplary device to a phone line, then a plain old telephone system (POTS) phone may become the equivalent of a PBX. The cost of the exemplary embodiment would be more like a few hundreds, instead of $1,000+ or more to have a PBX installed.

Remote PC

The PPD 100 device, according to another exemplary embodiment, may be used to access a device over the Internet. According to an exemplary embodiment, a file/email from a home PC may be obtained, and the user may be sent an email/or the system may try to sent it to another location.

Security and Triple-A (Authorizing, Authentication and Audit/Accounting)—Radius

The PPD 100 device, according to another exemplary embodiment, may be used along with a RSA device,or other security device, like a Radius server). Other authentications could be handled by the PPD 100 including, e.g., but not limited to, an identifier (e.g.,fingerprint/Iris scans, biometrics, etc.) and what the user knows (e.g., may require entry of a password and/or other input). Also, in an exemplary embodiment, the system may identify where the user is (which may be done with location information from the carrier). The system may identify what you have done . . . (i.e. are you following normal patterns of behavior, or psychographic (or behavioral) demographics. The PPD 100 may be used to provide an authentication signal when, e.g., a user is prompted to provide further authorization for a large credit card purchase. The Agovo KeyVob PPD 100 device may provide extensive additional information. For example, a thumb scanner on the PPD 100 device may be very small). A thumb scanner, or other biometric may be used to create a secure environment. Strong encryption is particularly useful in controlling access to corporate networks.

Location Access

The PPD 100 device, according to another exemplary embodiment, may be used to identify or access a location of a person. The PPD 100 may be used by one spouse who is not able to get the other spouse to answer the phone. In such a situation, the called party may be assumed to be on call, and the caller desires to know where the called party is. According to an exemplary embodiment, the user seeking the called party may send a location request to an Agovo presence service provider server according to the present invention, and may use a Time to Tower algorithm to derive an approximate location of the user (e.g., the person is still at office, on way home, etc.). Alternatively, the user could send a quick text message that the other person may reply to, by simply picking from a list of possible common responses.

Snap-on Enterprise Customizable Interface

According to an exemplary embodiment, the PPD 100 device may be customizable. For example, the PPD 100 may have a hardware interface to allow other devices to be modularly coupled to the PPD 100. For example, in an exemplary embodiment, a port such as, e.g., but not limited to, a USB interface, a Firewire Interface, or other access port may be provided. In an exemplary embodiment, accessories may be coupled to the PPD 100 including, e.g., a digital camera, a web cam, a printer, or other external peripheral accessory device.

According to one exemplary embodiment, radio frequency identifiers (RFIDs) may be used for position fixing and sensing movement. Rather than sense a location of a user at all time, like a GPS system does (which can use a lot of power and may not work indoors), an alternative location identification system may make use of RFID tags which may be placed in each of several locations where the user typically uses his or her mobile phone. The RFID tags might then be used to identify to the system the users location, either when the PPD 100 polls the tags, or the PPD 100 is made to communicate with the tag or other location identifier. Preferably using the RFIDs, the system may be a passive location identification system, and therefore will not take excessive batter usage.

While various exemplary embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to exemplary and preferred embodiments, it will be understood to those having ordinary skill in the art that changes in the above description or illustrations may be made with respect to formal detail without departing from the spirit and scope of the invention.

What is claimed is:

1. A method comprising:
receiving a registration from a user for an out-of-band signaling service provider, including:
associating at least one communications device with said out-of-band signaling service provider;
setting a plurality of possible locations of the user;
setting a plurality of possible levels of availability;
setting a plurality of possible modalities of communications; and
receiving a selection of an initial presence for the user, wherein said presence comprises a location selected from said plurality of possible locations, a level of availability selected from said plurality of possible levels of availability, and a modality of communication selected from said plurality of possible modalities of communications;
provisioning at a communication system a communications channel to route calls to the user according to said presence;
receiving a new selection of a new presence from the user over an out-of-band signaling system;
reprovisioning at the communications system to route calls to the user according to said new presence; and
sending an acknowledgement of receipt of said new selection of said new presence.

2. The method of claim 1, wherein said receiving said selections of said presence over said out-of-band signaling system comprises receiving said selections over a signaling system comprising at least one of:
a general packet radio service (GPRS) signaling system of global system for mobile communications (GSM) signaling technology,
a short messaging system(SMS),
a packet channel upon any mobile bearer channel,
a packet radio signaling system,
a two way packet pager signaling system,
a code division multiple access (CDMA) signaling system,
a WI-FI signaling system,
a WI-MAX signaling system,
a IP telephony signaling system,
a IP packet system to transmit packets,
a PSTN signaling systems employing voice recognition signaling,
an Interactive Voice Response (IVR) signaling,
a DTMF signaling, and/or
a Bluetooth signaling system that can communicate with any other Bluetooth compatible device that has wireless signaling capabilities outlined.

3. The method according to claim 2, wherein said packet channel upon any mobile bearer channel includes at least one of GSM, GPRS, CDMA, TDMA, iBurst, WiMax, WiFi, iDEN, UMTS, 1×EVDO, CDMA2000, W-CDMA, EDGE, an other 3rd generation wireless technology, a spread spectrum technology, a 4th generation wireless technology, HSDPA, HSUPA, a future generation wireless technology, a 5^{th} generation wireless technology, 6th generation wireless technology, 7th generation wireless technology, and nth generation wireless technology.

4. The method according to claim 2, wherein said IP telephony signaling system uses at least one of an MGCP, SIP, and/or RTP protocols.

5. The method according to claim 2, wherein said wireless signaling capabilities are adapted to communicate with a GSM cell phone or a Bluetooth Laptop on an IP network.

6. The method according to claim 2, wherein said IP packet system includes TCP/IP or UDP transport protocols to transmit packets.

7. The method according to claim 2, wherein said packet radio signaling system uses iText.

8. The method of claim 1, wherein said receiving said selections, comprises receiving said selections from a point of presence device.

9. The method according to claim 1, wherein said point of presence device comprises a signaling fob apparatus.

10. The method of claim 1, wherein said receiving said selections, comprises receiving an encrypted selection.

11. The method of claim 1, wherein said receiving said selections, comprises receiving said selections over a secure communications link.

12. A system comprising:
means for receiving a registration from a user for an out-of-band signaling service provider, including:
means for associating at least one communications device with said out-of-band signaling service provider;
means for setting a plurality of possible locations of the user;
means for setting a plurality of possible levels of availability;
means for setting a plurality of possible modalities of communications; and
means for receiving a selection of an initial presence for the user, wherein said presence
comprises a location selected from said plurality of possible locations, a level of
availability selected from said plurality of possible levels of availability, and a modality
of communication selected from said plurality of possible modalities of communications;
means for provisioning at a communication system a communications channel to route calls to the user according to said presence;
means for receiving a new selection of a new presence from the user over an out-of-band signaling system;
means for reprovisioning at the communications system to route calls to the user according to said new presence; and
means for sending an acknowledgement of receipt of said new selection of said new presence.

13. A computer program product embodied on a computer readable media, the computer program product adapted to enable a processor to execute a method comprising:
receiving a registration from a user for an out-of-band signaling service provider, including:
associating at least one communications device with said out-of-band signaling service provider;
setting a plurality of possible locations of the user;
setting a plurality of possible levels of availability;
setting a plurality of possible modalities of communications; and
receiving a selection of an initial presence for the user, wherein said presence
comprises a location selected from said plurality of possible locations, a level of
availability selected from said plurality of possible levels of availability, and a modality
of communication selected from said plurality of possible modalities of communications;
provisioning at a communication system a communications channel to route calls to the user according to said presence;
receiving a new selection of a new presence from the user over an out-of-band signaling system;
reprovisioning at the communications system to route calls to the user according to said new presence; and
sending an acknowledgement of receipt of said new selection of said new presence.
